(19) United States
(12) Patent Application Publication
(10) Pub. No.: US 2019/0045816 A1
(43) Pub. Date: Feb. 14, 2019

(54) ETHYLENE CONTROL ACROSS MULTIPLE STAGES OF A DISTRIBUTION CHAIN

(71) Applicant: CARRIER CORPORATION, Palm Beach Gardens, FL (US)

(72) Inventors: Robert A. Chopko, Baldwinsville, NY (US); Renee A. Eddy, Manlius, NY (US); James J. Minard, Roscoe, IL (US); Ciara Poolman, Syracuse, NY (US)

(73) Assignee: CARRIER CORPORATION, Palm Beach Gardens, FL (US)

(21) Appl. No.: 16/076,437

(22) PCT Filed: Feb. 8, 2017
(86) PCT No.: PCT/US17/16930

§ 371 Date: Aug. 8, 2018

Related U.S. Application Data
(60) Provisional application No. 62/293,169, filed on Feb. 9, 2016.

(51) Int. Cl. A23L 3/3445; B65D 81/26; B65D 81/28; B65D 88/12; B65D 88/74; B65B 25/04

(52) U.S. Cl. CPC A23L 3/3445; B65D 81/266; B65D 81/28; H04L 67/125; B65D 88/745; B65B 25/041; A23V 2002/00; B65D 88/12

(57) ABSTRACT

A transport container for multiple stages of a distribution chain is provided. The transport container includes a power source providing electrical power to the transport container. An ethylene injection unit configured to store and inject ethylene into the transport container. A controller in operative communication with the power source and the ethylene injection unit. The controller is configured to command the ethylene injection unit to inject ethylene into the transport container along the multiple stages of the distribution chain.

### BACKGROUND OF THE DISCLOSURE

The embodiments disclosed herein generally relate to transport containers and control of the ripening process of perishable goods within such containers.

Typically at harvest, perishable goods are placed within simple transport containers, such as, for example, cardboard boxes, wooden crates or burlap bags. These containers typically provide little assistance to the ripening of perishable goods. Often times, distribution chains have become so efficient and fast that perishable goods arrive at the final end consumer before they are ripe and thus the goods cannot be consumed immediately. This process is inefficient, since perishable goods must linger in end consumers' inventory to fully ripen.

### BRIEF DESCRIPTION OF THE DISCLOSURE

According to one embodiment, a transport container for multiple stages of a distribution chain includes a power source providing electrical power to the transport container. Also included is an ethylene injection unit configured to store and inject ethylene into the transport container. Further included is a controller in operative communication with the power source and the ethylene injection unit. The controller is configured to command the ethylene injection unit to inject ethylene into the transport container along the multiple stages of the distribution chain.

In addition to one or more of the features described above, or as an alternative, further embodiments may include at least one sensor in operative communication with the controller, wherein the at least one sensor is configured to sense at least one environmental condition within the transport container and communicate the at least one environmental condition to the controller.

In addition to one or more of the features described above, or as an alternative, further embodiments may include a communication module in operative communication with the controller and wireless operative communication with a remote controller, wherein the communication module is configured to transmit the at least one environmental condition to the remote controller.

In addition to one or more of the features described above, or as an alternative, further embodiments may include wherein the communication module is configured to receive at least one remote command from the remote controller and transmit the at least one remote command to the controller.

In addition to one or more of the features described above, or as an alternative, further embodiments may include wherein the transport container is composed of an insulating material.

In addition to one or more of the features described above, or as an alternative, further embodiments may include a carbon dioxide scrubber configured to remove carbon dioxide from the transport container.

In addition to one or more of the features described above, or as an alternative, further embodiments may include wherein a portion of the transport container is transparent.

In addition to one or more of the features described above, or as an alternative, further embodiments may include an environmental control unit configured to produce and distribute conditioned air throughout the transport container.

In addition to one or more of the features described above, or as an alternative, further embodiments may include wherein the power source comprises one or more of a battery, a solar cell, and a gas powered generator.

According to another embodiment, a method of operating a transport container across multiple stages of a distribution chain, the method is provided. The method includes electrically powering, using a power source internal to the transport container, a plurality of components of the transport container. The method also includes injecting, using an ethylene injection unit, ethylene in the transport container. The method further includes controlling, using a controller, a plurality of components of the transport container, wherein controlling comprises operating the power source and the ethylene injection unit. The method yet further includes adjusting, using the controller, the operation of the ethylene injection unit along the multiple stages of the distribution chain.

In addition to one or more of the features described above, or as an alternative, further embodiments may include monitoring, using at least one sensor, at least one environmental condition within the transportation container; and communicating the at least one environmental condition to the controller.

In addition to one or more of the features described above, or as an alternative, further embodiments may include wirelessly transmitting, using a communication module in operative communication with the controller, the at least one environmental condition to a remote controller.

In addition to one or more of the features described above, or as an alternative, further embodiments may include receiving, using the communication module, at least one remote command from the remote controller; and transmitting the at least one remote command to the controller.

In addition to one or more of the features described above, or as an alternative, further embodiments may include wherein the transport container is composed of an insulating material.

In addition to one or more of the features described above, or as an alternative, further embodiments may include removing, using a carbon dioxide scrubber, carbon dioxide from the transport container.

In addition to one or more of the features described above, or as an alternative, further embodiments may include wherein a portion of the transport container is transparent during at least one stage in the distribution chain.

In addition to one or more of the features described above, or as an alternative, further embodiments may include producing and distributing conditioned air throughout the transport container, using an environmental control unit internal to the transport container.

In addition to one or more of the features described above, or as an alternative, further embodiments may include wherein the power source comprises one or more of a battery, a solar cell, and a gas powered generator.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 illustrates a schematic view of a transport container with a ripeness control system; and

FIG. 2 is a flow diagram of a typical perishable goods distribution chain.

### DETAILED DESCRIPTION OF THE DISCLOSURE

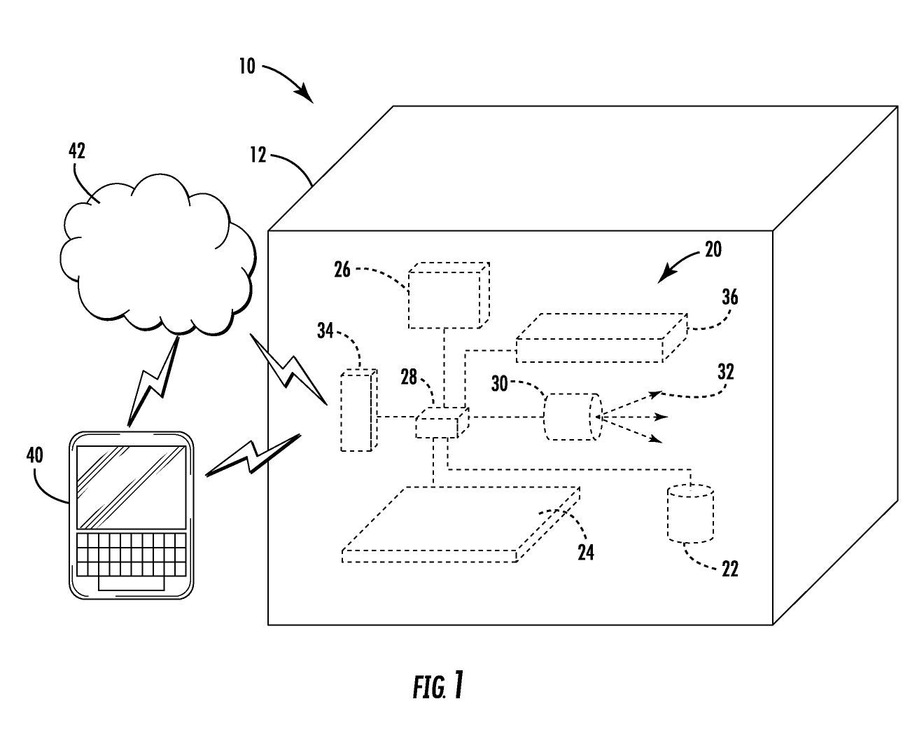

Referring now to the drawings, FIG. 1 illustrates a schematic view of a transport container 10 with a ripeness control system 20. In the illustrated embodiment, the transport container 10 includes a power source 24 providing electrical power to the transport container 10, an ethylene injection unit 30 configured to store and inject ethylene 32 into the transport container 10; a controller 28 in operative communication with the power source 24 and the ethylene injection unit 30. The controller 28 is configured to command the ethylene injection unit 30 to inject ethylene 32 into the transport container 10. In one embodiment, the controller 28 may be a simple timer that is set to release ethylene 32 at specific time intervals. Whereas, in another embodiment, the controller 28 may be an electronic controller including a microprocessor and an associated memory bank. The power source 24 may be a battery or power generation device including, but not limited to, primary cell batteries, secondary cell batteries, gas powered generators, or solar cells. The ethylene injection unit 30 may include but is not limited to a canister to hold the ethylene 32 and a sprayer to inject the ethylene 32 into the transport container 10.

In the illustrated embodiment, the transport container 10 may further include, but is not limited to, at least one sensor 22, a communication module 34, and a carbon dioxide scrubber 26. In the illustrated embodiment, the at least one sensor 22 is in operative communication with the controller 28, the at least one sensor 22 is configured to sense environmental conditions within the transport container 10, such as, for example, temperature, pressure, humidity, carbon dioxide, ethylene, vibrations, light exposure, duration of travel and Global Positioning System (GPS) location. In further embodiments, the at least one sensor 22 may also be able to automatically sense the perishable goods within the transport container 10. The at least one sensor 22 may be able to distinguish the type of perishable goods via many sensing techniques including but not limited to optical, odor, soundwave, infrared, and via a physical probe. By identifying the perishable goods within the transport container 10 and sending that information to a cloud computing network 42, ripeness could be continually monitored, even if the perishable goods switch transport containers 10.

In the illustrated embodiment, a communication module 34 is in operative communication with the controller 28 and wireless operative communication with a remote controller 40. In further embodiments, the communication module 34 may be connected to the remote controller 40 via short range wireless communication or connected through a cloud computing network 42. The wireless communication may be but is not limited to radio, microwave, WiFi, Bluetooth, satellite networks, cellular networks or another wireless communication method. In further embodiments, the remote controller 40 may be but is not limited to a dedicated remote controller device, cellular phone, tablet, laptop, smartwatch, a desktop computer or any other similar device. In the illustrated embodiment, the communication module 34 is configured to transmit the at least one environmental condition to a remote controller 40 located off the transport container 10. In the illustrated embodiment, the communication module 34 is configured to receive at least one remote command from the remote controller 40 and transmit the at least one remote command to the controller 28.

In the illustrated embodiment, the carbon dioxide scrubber 26 is configured to remove carbon dioxide from the transport container 10. Carbon dioxide may need to be removed from the transport container 10 to aid in the effectiveness of the ethylene 32. In a further embodiment, not illustrated, a portion of the outer surface 12 of the transport container 10 may be transparent. In a further embodiment, that a cover may extend over the transparent portion or transparent portion itself may change to translucent or opaque if the perishable cargo has been exposed to too much light, as sensed by the at least one sensor 22.

The perishable goods within the transport container may be cooled or heated as required by an environmental control unit 36. In one embodiment, the environmental control unit 36 may be a part of the ripeness control system 20 within the transport container 10 and is configured to produce and distribute conditioned air throughout the transport container 10. The environmental control unit 36 is electrically powered by the power source 24 and is in operative communication with the controller 28. In another embodiment, the transport container 10 may be composed of an insulating material to aid in temperature control. The insulating material may be but is not limited to plastic, metal vacuum, extruded polystyrene foam, polyurethane foam, polyethylene foam, or other lightweight insulating material.

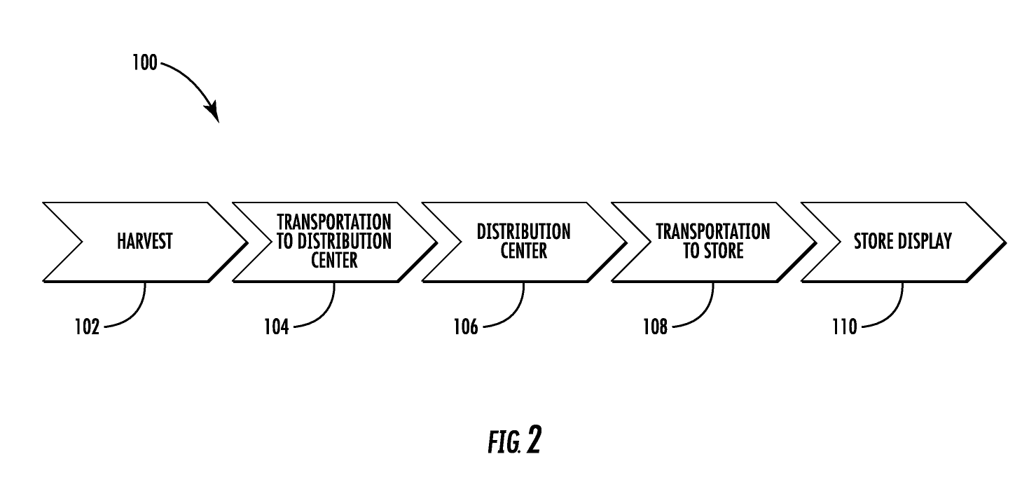

Referring now to FIG. 2, which illustrates a flow diagram of a typical perishable goods distribution chain 100. In the illustrated embodiment, a typical perishable goods distribution chain 100 usually includes but is not limited to the five basic stages pictured in FIG. 2: (1) harvest 102, (2) transportation to distribution center 104, (3) distribution center 106, (4) transportation to store 108, and (5) store display 110. It is important to note that these stages are provided for illustrative purposes and a distribution chain may include fewer stages or additional stages, such as, for example a cleaning stage, a processing stage, a packaging stage, and additional transportation stages. In the illustrated embodiment, the distribution chain 100 starts at harvest 102. In further embodiments, harvest 102 may include but is not limited to the harvesting of fruits, vegetables, grains, beans, nuts, eggs, dairy, seed, flowers, meat, poultry, and fish from the source where the item is grown, produced, or raised.

Typically at the harvest 102 stage, perishable goods are placed within simple transport containers, such as, for example, cardboard boxes, wooden crates or burlap bags. These containers typically provide little assistance to the ripening of perishable goods. The transport container 10 illustrated in FIG. 1 could provide ripening assistance to the perishable goods throughout the entire distribution chain 100. Ethylene 32 aids in the ripening process of perishable goods and injecting ethylene 32 into the transportation container 10 can ensure that perishable goods are ripe as soon as they are received by the end consumer. Often times, distribution chains 100 have become so efficient and fast that perishable goods arrive at the final end consumer not ripe and thus the goods cannot be consumed immediately. This process is inefficient as perishable goods must linger in end consumers' inventory to fully ripen. For instance, this is a problem for restaurant chefs who want ripe ingredients on a daily basis but do not have the room within their kitchens to store the perishable goods to ripen.

The perishable goods could be placed in the transportation container 10 at the harvest 102 stage or any other stage. Once within the transportation container 10, the controller 28 could initiate the release of ethylene 32 from the ethylene injection unit 30 to ripen the perishable goods on route to its final stage. In one embodiment, the controller 28 may operate on a timed release of ethylene 32 based on the current ripeness of the perishable good and the distance to the final stage. In alternate embodiments, the controller 28 may utilize sensors 22 to sense the environmental conditions within the transport container 10 and the ripeness of the perishable goods. The controller 28 could then use the sensed information to increase or decrease the amount of ethylene 32 within the transport container 10. In further embodiments, the controller 28 may also use the GPS location of the transport container 10 to estimate the remaining travel time in the distribution chain 100 and then adjust the ethylene 32 injections accordingly. In further embodiments, the controller 28 may contain algorithms and curves of the ripening schedules of perishable goods to aid the controller 28 in determining how much ethylene 32 is required so that the perishable goods reach peak ripeness once the distribution chain 100 is complete.

The transport container 10 is configured to operate across multiple stages of a distribution chain 100 and could even carry the perishable goods across the distribution chain 100 from harvest 102 all the way to the store display 110. The store display 110 stage may be but is not limited to a grocery store, restaurant, vending machine or any other general display case. In alternative embodiments, different transport containers 10 may be used in different stages, however the ripeness of the perishable goods is continually monitored via the cloud computing network 42 throughout the entire distribution chain 100. In further embodiments, a portion of the transport container 10 is transparent during at least one stage the distribution chain 100. Having a portion of the transportation container 10 transparent allows workers to visibly check the health of the perishable goods during any stage and also allows the transport container 10 to be used as a display case for customers to purchase the perishable goods at the store display 110 stage. In another further embodiment, the environmental control unit 36 may be permanently installed in the transport container or may be removable only to be used during select stages of the distribution chain 100. For instance, the environmental control unit 36 may only be utilized at the store display 110 stage to save weight during the travel stages of the distribution cycle 100. Further, in yet another embodiment, the transportation container 10 may be alternatively powered by an exterior power source when one is available. For example, an exterior power source may be utilized at the store display 110 stage.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. A transport container for multiple stages of a distribution chain comprising:
a power source providing electrical power to the transport container;
an ethylene injection unit configured to store and inject ethylene into the transport container; and
a controller in operative communication with the power source and the ethylene injection unit, wherein the controller is configured to command the ethylene injection unit to inject ethylene into the transport container along the multiple stages of the distribution chain.

2. The transport container of claim 1, further comprising:
at least one sensor in operative communication with the controller, wherein the at least one sensor is configured to sense at least one environmental condition within the transport container and communicate the at least one environmental condition to the controller.

3. The transport container of claim 2, further comprising:
a communication module in operative communication with the controller and wireless operative communication with a remote controller, wherein the communication module is configured to transmit the at least one environmental condition to the remote controller.

4. The transport container of claim 3, wherein:
the communication module is configured to receive at least one remote command from the remote controller and transmit the at least one remote command to the controller.

5. The transport container of claim 4, wherein:
the transport container is composed of an insulating material.

6. The transport container of claim 5, further comprising:
a carbon dioxide scrubber configured to remove carbon dioxide from the transport container.

7. The transport container as in claim 6, wherein:
a portion of the transport container is transparent.

8. The transport container as in claim 6, wherein:
a portion of the transport container is transparent.

9. The transport container of claim 7, further comprising:
an environmental control unit configured to produce and distribute conditioned air throughout the transport container.

10. The transport container of claim 9, wherein:
the power source comprises one or more of a battery, a solar cell, and a gas powered generator.

11. A method of operating a transport container across multiple stages of a distribution chain, the method comprising:
electrically powering, using a power source internal to the transport container, a plurality of components of the transport container;
injecting, using an ethylene injection unit, ethylene in the transport container;
controlling, using a controller, a plurality of components of the transport container, wherein controlling comprises operating the power source and the ethylene injection unit; and
adjusting, using the controller, the operation of the ethylene injection unit along the multiple stages of the distribution chain.

12. The method of claim 11, further comprising:
monitoring, using at least one sensor, at least one environmental condition within the transportation container; and
communicating the at least one environmental condition to the controller.

13. The method of claim 12, further comprising:
wirelessly transmitting, using a communication module in operative communication with the controller, the at least one environmental condition to a remote controller.

14. The method of claim 13, further comprising:
receiving, using the communication module, at least one remote command from the remote controller; and
transmitting the at least one remote command to the controller.

15. The method of claim 14, wherein:
the transport container is composed of an insulating material.

16. The method of claim 15, further comprising:
removing, using a carbon dioxide scrubber, carbon dioxide from the transport container.

17. The method as in claim 15, wherein:
a portion of the transport container is transparent during at least one stage in the distribution chain.

18. The method as is claim 16, wherein:
a portion of the transport container is transparent during at least one stage in the distribution chain.

19. The method of claim 17, further comprising:
producing and distributing conditioned air throughout the transport container, using an environmental control unit internal to the transport container.

20. The method of claim 19, wherein:
the power source comprises one or more of a battery, a solar cell, and a gas powered generator.
